(19) United States
(12) Patent Application Publication
(10) Pub. No.: US 2023/0063594 A1
(43) Pub. Date: Mar. 2, 2023

(54) FANTASY SPORTS GAME SYSTEM AND METHOD WITH MULTI-LEAGUE PLAY

(71) Applicant: Legacy Fantasy Sports LLC, Rochester Hills, MI (US)

(72) Inventor: Grady Toombs, Shelby Township, MI (US)

(21) Appl. No.: 17/885,841

(22) Filed: Aug. 11, 2022

Related U.S. Application Data
(60) Provisional application No. 63/232,733, filed on Aug. 13, 2021.

(51) Int. Cl. A63F 13/828; A63F 13/46; A63F 13/65; A63F 13/798; A63F 13/795; A63F 13/335

(52) U.S. Cl. CPC A63F 13/828; A63F 13/46; A63F 13/65; A63F 13/798; A63F 13/795; A63F 13/335

(57) ABSTRACT

A computer-implemented method for operating a fantasy sports system facilitates the creation of a team using players across multiple sports. Each fantasy team on the server is created using sets of players from at least a first league and a second league. The server generates a set of points corresponding to each league for each player. The server then combines the points corresponding to each league for a given player into that players total score.

### CROSS-REFERENCE TO RELATED APPLICATION

This application claims priority to U.S. Non-Provisional Patent Application No. 63/232733 filed on Aug. 13, 2021.

### BACKGROUND

Fantasy sports are a popular way for people to interact in a different, immersive way with their favorite sports and their favorite athletes. Generally, each user “drafts” a team of active players to their roster. Each user then designates from their roster a starting lineup for their team each round (e.g. each week for football). The starting lineup may be limited to a certain number of players at each available position. For fantasy football, a user may typically choose a team defense/special teams, or they may be permitted to choose one or more individual defensive players.

Players in the starting lineup acquire points for each user based upon their statistical performance in that round (e.g. one game). The user's fantasy team accumulates points as a total of the fantasy points acquired by all the players in the user's starting lineup that round. Players on the roster, but not in the starting lineup, do not count toward the user's fantasy team's points. Competitions are often head-to-head. The fantasy team that accumulates more points in that round wins that competition.

Competitions may be a single round, i.e. a single head-to-head contest, or a single contest among more than two users. Typically a “round” is a time where each player plays one game (ignoring bye weeks of injuries). Competitions may also be leagues, i.e. multiple rounds involving a series of head-to-head competitions.

In one example for fantasy football, each user may draft or acquire on their roster sixteen players, including nine starters and seven bench players. The starters may include, for example, 1 quarterback, 2 running backs, 2 wide receivers, 1 tight end, 1 kicker, 1 defensive player, and 1 “flex” position (which may be used to start another running back or wide receiver or tight end). Bench players do not accumulate points for the user's team, but may be swapped into a starting lineup before each round.

In each round for league play (or in a single contest), the users designate their starting lineups. In a league, between rounds, the user can swap players between their starting lineup and bend', make trades, acquire undrafted players, etc.

In an example league, the competitions in each round (week) are head-to-head, so that for each pair of competing users, the user's team who accumulates more points that round wins. Among the teams in a league, the standings are typically based upon who has the best record in the head-to-head contests.

In single round contests, again the user's team with more points wins. Contests may also be among more than two teams, often dozens of teams, and the winner is the user whose team has the most points.

Each starting player accumulates fantasy points for the fantasy team based upon that player's performance in actual competition that week. More specifically, that player's fantasy points are based upon their individual performance statistics. Scoring based upon the individual performance statistics can vary among leagues. For example, a player may accumulate 6 points per touchdown scored by rushing, receiving or passing. A player may accumulate 1 point per 10 yards rushing or receiving (and optionally, for any fraction thereof, such that tenths of a point are accumulated for each yard), and 1 point per 25 yards passing.

Negative points can also be added to a player's fantasy points. For example, a player who loses a fumble or throws an interception will receive negative 2 points.

Kickers may accumulate fantasy points as follows, for example: 6 points per field goal made greater than or equal to 60 yards. 5 points per field goal made between 50-59 yards, 4 points per field goal made between 40-49 yards, 3 points per field goal made less than or equal to 39 yard, and 1 point per extra point made. Optionally, negative points can be added to a kicker's fantasy points, for example: negative 2 points for each missed extra point, negative 2 points for each field goal missed less than 40 yards, and negative l point for each field goal missed or blocked from 40 to 49 yards.

A defensive player receives 2 points for a blocked kick, 2 points for a safety, 1 point for a forced fumble, 1 point for a recovered fumble, 2 points for an interception and 1 point for a sack.

Entry fees may be collected from users who choose to join a league or contest. Winners of contests or leagues may receive a payout, based upon the size of the contest/league and the entry fees.

### SUMMARY

A computer-implemented method for operating a fantasy sports system permits the drafting and playing of non-active players. The non-active players can be drafted alongside active players, or a team, a contest or even a league can be comprised of exclusively non-active players. These non-active players then accumulate fantasy points as described above and are used in single-round contests and in fantasy leagues, as described above.

In the method disclosed herein, a plurality of player selections are received from a plurality of users for each of their rosters. At least some of the plurality of player selections are for non-active players. A fantasy team is created for each of the plurality of users based upon their player selections. Fantasy points are generated for each of the non-active players by randomly selecting a plurality of historical plays by each non-active player from a database of historical plays. A total fantasy score for each fantasy team is generated based upon the fantasy points for each of the non-active players.

The generation of fantasy points for each non-active player may include determining a game duration and a number of plays. This permits the player's fantasy points to be released in real-like time, over the course of a simulated game on a game day. Fantasy points are generated for each of the non-active players at randomly-determined time intervals that are based upon the determined game duration and number of plays.

The player selections from the users can also include active players, so that active and non-active players can be included on the same team and the same starting lineup. The fantasy points acquired by the active players in the starting lineup are added to the fantasy points generated for the non-active players in the lineup to create the team score.

In the example described herein, the fantasy sport is fantasy football, but other sports could also be implemented similarly. Any sport that can be played as a fantasy sport can utilize the inventions described herein.

An optional multi-league contest is disclosed herein. Each user selects a player from each of a plurality of leagues established by the contest creator. Each user selects the same number of players from the same leagues. Preferably, the leagues are different sports.

### BRIEF DESCRIPTION OF THE DRAWINGS

FIG. 1 is a flowchart for creating a roster and a lineup.

FIG. 2 is a flowchart for executing a game for a non-active player.

FIG. 3 shows a lineup screen that is displayed in an app on a user's smartphone.

FIG. 4 shows a standings screen that is displayed in the app on the user's smartphone.

FIG. 5 shows a live contest screen that is displayed on the user's smartphone,

FIG. 6 shows the live contest screen of FIG. 5, with two contests in which the user is participating.

FIG. 7 shows a flow chart implementing one possible method for generating random numbers, which could be used in the method of FIG. 2.

FIG. 8 is a flow chart implementing league play and contest play.

FIG. 9 is flow chart showing an optional method for converging a non-active player's FPPG toward the player's historical FPPG.

FIG. 10 is an example schematic of a fantasy sports system according to one embodiment.

FIG. 11 is a schematic for an optional multi-league contest.

### DETAILED DESCRIPTION OF PREFERRED EMBODIMENTS

The present invention uses a method for creating and running leagues, contests, and games for, but not limited to, fantasy sports. The present invention is a legacy fantasy sports service which incorporates an Application Program Interface (API) and the commercially available library of historic and real-time statistical sports data. The combination of the API and the data is then used to create fantasy leagues, seasons, contests, and games. These leagues, seasons, contests, and games are then provided through a fantasy sports entertainment software as a service (SAAS). The present invention may also be used within other fantasy platforms through the invention's own platform API.

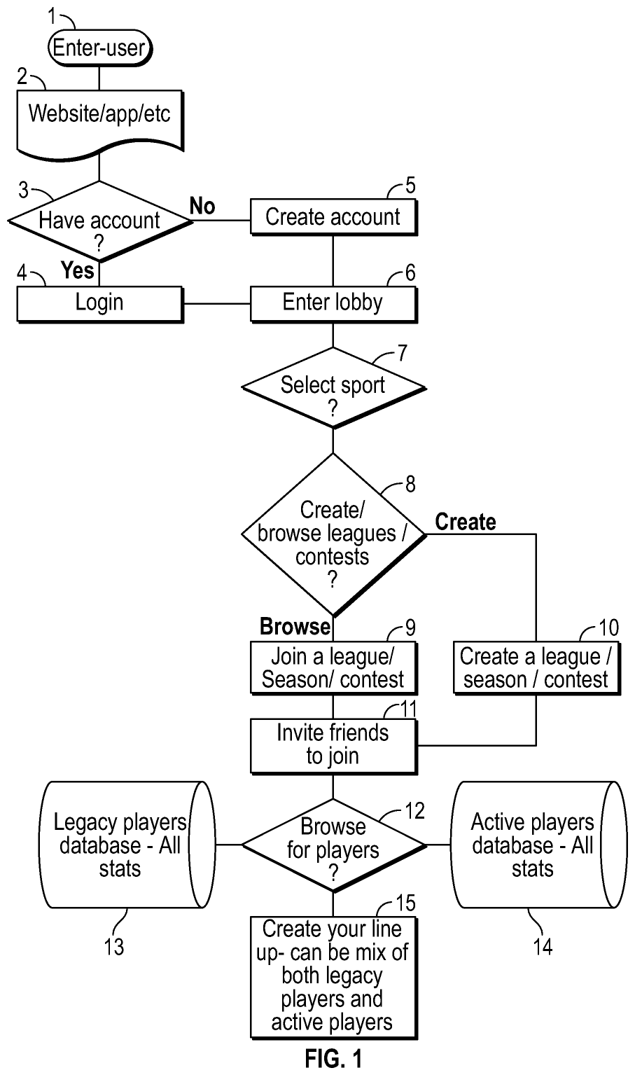

Referring to FIG. 1 a flowchart, to enter in step 1 the platform a user can go to a website, app, or the like in step if the user has an account 3 they will be guided to log in step 4, if they do not have an account they will be guided to create an account in step 5. Once logged in, the user will enter the lobby in step 6. At this point they will be asked to select a sport in step 7. then given a decision to create or browse a league/season/contest in step 8. If the user chooses to browse for a currently active leagues/season/contest, they will continue to search until they find one that matches their needs and start times. Once found, the user will join the league/season/contest with other users in step 9. If desired, the user can create their own league/season/contest in step 10. Once inside the league/season/contest user may invite their friends to join and also participate in the league/season/contest in step 11. Each league should have a minimum of two users/teams. Although there is no maximum number of teams in a league, a reasonable number would be between six and thirty. Preferably there are at least six teams in a league. It is anticipated that the platform will host over one million leagues simultaneously, with tens of millions of teams, each with their own roster.

A league is a group of teams that are formed and organized to compete against each other. A season is the number of games played during a set number of weeks between the teams in the league. In other words, a league is a quantity of teams, and a season is the duration for which that quantity of teams play each other. The season may or may not be the same as the live season upon which the sport is based, even if active players are used.

In Daily Fantasy Sports are primarily individual contests between users, either head to head, or in a tournament style of play. The contests are typically one-round (in football, one day or one week). The wagering system works as follows. In a head-to-head contest, two contestants want to play each other. They wager $100 apiece on the contest. The winner gets $170.00 and the platform would get $30.00 (for example) as the service charge for using the platform to create the contest. In a multi-player game, the same format would apply: 10 players wager $100 apiece, with the winner taking $850.00 and the platform retains $150.00. These are examples of private games that the users set up for themselves.

A public contest set up by the platform may indicate to the contestants prior to the game what the prize will be (because the number of participating players is not known in advance).

At this point, it is time for the users to draft players onto their teams (rosters). This is done by browsing for available players in step 12 from either a non-active player database list 13 and/or active player database list 14. Using NFL football as an example, the active player list may make available approximately 400 players in any given week. In the present system, over 15,000 additional non-active players would become available. As an example, each roster may have sixteen players.

The non-active player database list 13 is a database of every play involving each of a plurality of non-active (e.g. retired) players. For example, the database list 13 may include a history of plays for over 1000 non-active players and more preferably for over 15,000 non-active players. Using over 15,000 non-active players, the database list 13 would include approximately 854,000 historical plays. The active player database list 14 is a list of an active players available to generate real-time data during the season after Which they are selected or any remaining games after which they are selected. The database list 13 could also include non-active (historical) data. for active (non-retired) players.

Line-ups (that is, starting lineups) are created in step 15. Line-ups can be a mix of both legacy (non-active) players from the non--active player database list 13 and active players from active player database list 14. Alternatively, the line-ups can include just players from the non-active player database list 13, or users can choose to have only active players. Some rules may be chosen independently for each league or contest. Once all the team's starting lineups have been filled and the game scheduler hits game time, the game begins. For example, as explained above, users may be placed in head-to-head matchups in each round to see whose starting fantasy lineup generates more points. As another example, single-round contests among two or more users can be played. As will be explained below, users see game plays/stats appear for non-active players just like they would with regular real-time fantasy sports.

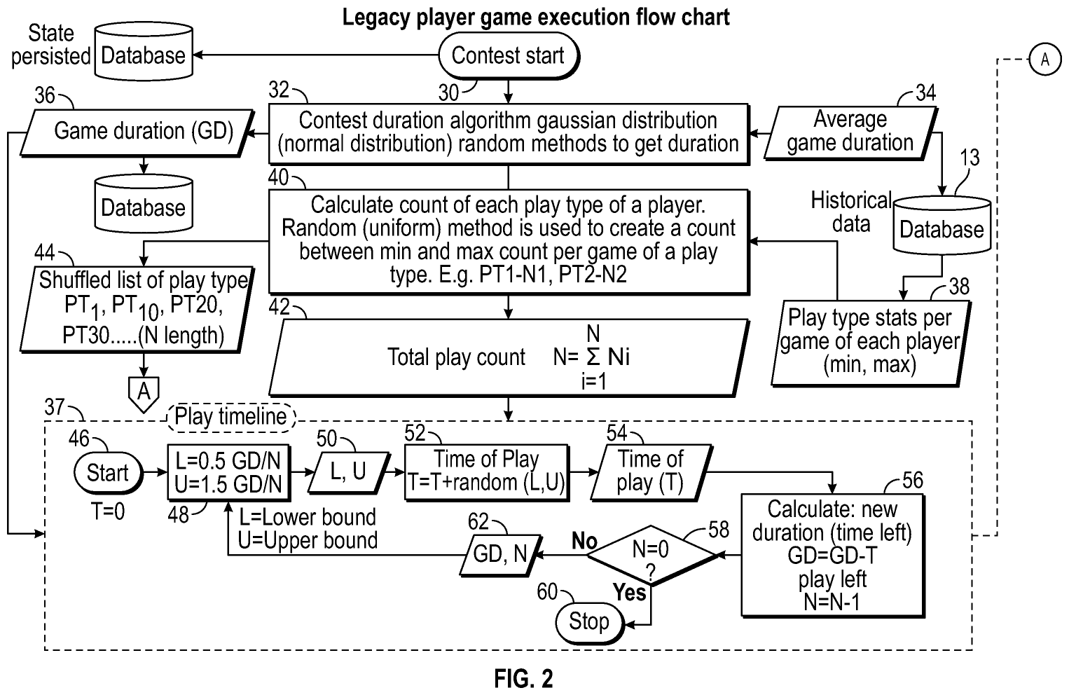

FIG. 2, a schematic illustration, defines the engine of the platform for calculating fantasy points for one game for one non-active player. When the contest is started in step 30, a Contest Duration (game duration) is determined in step 32 from an algorithm using a Gaussian distribution (normal distribution) of previous games from the historical database 13 and average game duration 34 from the historical database 13 and a random method to get a Contest Duration, The game duration 36 is sent to the play timeline 37.

Play type stats per game for the non-active player are retrieved from the database 13 in step 38. In step 40, the system calculates the count of each play type of the player. A random method is used to create a count between minimum and maximum count per game of each play type. The play type for each play is sent to the play timeline 37 in step 42. A shuffled list of play types is generated in step 44.

The play timeline 37 starts in step 46. In step 48, an upper bound and lower bound for the time of each play are determined, For example, the lower bound may be half the total game duration divided by the number of plays. The upper hound may be 1.5 times the total game duration divided by the number of plays. The lower and upper bounds 50 are used in step 52 to determine a time of play 54. The time of the play 54 is determined to be randomly between the lower and upper bounds 50. In step 56, a new game duration, i.e. the time remaining in the game, is determined by subtracting the latest time of play 54 from the previous Game Duration. The number of plays N is also reduced by one.

In step 58, if the number of plays remaining reaches zero, then play is stopped in step 60. If not, then the new Game Duration and number of plays 62 are stored and used in step 48 again to calculate the next play duration (with a new lower bound and upper bound 50). After all of the plays N have been assigned a play type 44 (PT) and a time of play 54 (T), the play timeline 37 is ended in step 60.

In step 64, all of the play times 54 and the list of play types 44 are then used to schedule play types 44 at each play time 54 in step 66.

In step 68, each play is initiated when the time for each play occurs. In step 70, the system then randomly fetches an integer (e.g. as described further below). The random value 72 is used in the play selection step 74. The random value 72 may need to be processed in step 74, e.g. because the random number may be outside the range of play indices. For example, if there are only 1000 historical plays of a certain play type for the particular player, but the random value is 7891, then the modulo of the random value would yield 891 to use to index the historical play database.

The play is selected based upon the random integer value 72 and based upon the selected play type that has already been assigned. The random integer value is used to index a play type played index 78, which selects plays from a database 76 based upon the player, based upon the specified play type and based upon the random integer value. The random integer value is used to index the historical database of plays by that player of the selected play type in step 80 at the designated time of the play.

The selected historical play is executed at time T in step 80 and recorded in database 86. This algorithm stops in step 84 until it is time for the next play for that player.

It should be recognized that the flowchart of FIG. 2 is running simultaneously and independent for hundreds of non-active players on a “game day.” The executed plays from step 80 are stored in the database 86 for all non-active players and reported to the users to be used in the contests and fantasy league competitions.

Optionally, possibly according to each contest's or each league's own designated rules (e.g. via a checkbox) in the event that an active player in a starting lineup does not play in that round, a player in the same position is automatically moved from that user's bench to that user's starting lineup. This preferably occurs prior to gametime, but alternatively could be processed in hindsight after it is determined that an active player did not incur any playing time in a round.

The flowchart of FIG. 2 will now be explained for an example non-active quarterback. The flowchart of FIG. 2 is specifically for a contest, but may also be used for one round in a league (possibly with minor modifications). The contest duration may be the same for any player type, and during a round of the fantasy league, the contest duration 36 may be calculated once for the league and used for all non-active players. Alternatively, in a league, the contest duration 36 may be calculated independently for each non-active player. For example, the contest duration 36 may be randomly determined based upon historical data to be 3.0 hrs.

For a quarterback, the possible play types may include: completed pass, incomplete pass, completed pass for touchdown, interception, and rush (a rush by the qb). From the historical database 13 the play stats per game for this particular non-active quarterback in step 38 may be (for example):

| | complete pass | incomplete pass | interception | rush | fumble |
|---|---|---|---|---|---|
| min | 12 | 8 | 0 | 1 | 0 |
| max | 27 | 25 | 2 | 9 | 1 |

In other words, the minimum number of completed passes for this player in a game the historical data is 12, and the maximum is 27. The minimum number of incompletions is 8 and the maximum number is 25. The minimum number of interceptions in a game is zero and the maximum for this player is 2. The minimum number of rushes by this quarterback is 1 and the maximum is 9. The minimum number of fumbles by this quarterback is zero and the maximum is 1.

In step 40 in this example, a random number of each play type is selected that is between each associated minimum and maximum. For example, step 40 may generate for this non-active quarterback 22 completions, 14 incompletions, 1 interception, 3 rushes and zero fumbles. These will be the play types for this player for this game.

The total play count for this non-active player for this contest would be calculated in step 42 as 40. In step 44, the list of play types generated in step 40 is shuffled for this player to create a randomly sequenced list of the play types, e.g. completion, rush, completion, completion 3, incompletion, incompletion, incompletion, completion, completion, etc (for all forty plays).

In the play timeline 37, in the first iteration, the lower bound is half of 3.0 hrs/40 plays, which is 2.25 minutes, and the upper bound is 1.5 times 3.0 hrs/40 plays, which is 6.75 minutes. In step 52, the time of the first play for this player is randomly selected between 2.25 mins and 6.75 mins. If this time of play 54 is randomly determined to be 3 mins, the first time of play 54 (3 mins) and the first play type (in this case a completion) are associated with the first play.

In the next iteration, the remaining game time is 3.0 hrs minus 3 minutes, which is 177 minutes, which is used to calculate the new lower bound and upper bound. For example, the new lower bound would be half of 177 minutes/39 plays, which is 2.27 minutes, and the new upper bound is 6.81 minutes. The time of the second play may be randomly selected to be between the upper bound and lower hound. For example, the second play may be randomly selected to be 4 minutes (integers are used in this example for simplicity but fractions of a minute could be used), i.e. 4 minutes after the first play. This iterative calculation of the times of play continues until times of play are calculated for all of the plays for this player in this game (in this example, all 40 plays).

Note that the last play by this player is unlikely to occur exactly at the end of the game duration, and could be several minutes before or after the calculated game duration. In the iteration where N=1 (the last play by this player), the lower bound will be half the remaining game time (in which case the last play could be several minutes before the end of the calculated game duration) and the upper hound will be 1.5 times the remaining game time (which could be several minutes after).

In step 64, the play times are determined based upon the time of play 52 that was determined for each of the 40 plays. In step 66, the play types are scheduled at the calculated game times. The contest for the non-active players may begin at or around the same time that the actual live games begin for the active players. That way, points will show up for the non-active players over roughly the same period that points appear for the active players (or, if only non-active players are being used, then over roughly the same period that points would appear for active players).

At the first play time, in step 70 for the example quarterback, a random integer is fetched (e.g. using one of the methods described herein). The value 72 is used to index a play of the first play type (in this example, a completion). Using the random integer, the play type played index 78 is indexed, and retrieves one of the historical plays by this player of the selected play type. One of this quarterback's completions is indexed by the random number. The values from that historical play are retrieved, the play is executed in step 80 and stored in the database 86. Those stats and those fantasy points for that play for that player are then published to the users and added to the fantasy points for teams that have that player in their starting lineup. For example, if the randomly indexed play of play type completion for this quarterback was a completion of 34 yards and a touchdown, then that would generate 1 points for the yards plus 6 points for the touchdown. In other words, the play type “completed pass” is indexed for both the yards and whether or not that pass was for a touchdown. That play, those stats and those points would be published to the users at the first time of play (in this case, 3 mins after game start). Alternatively, “passing touchdown” could be an independent play type with its own min, max play count.

Step 70 is repeated for each of the forty plays for this example quarterback. The second play is performed at the time of the second play, in this example, 4 minutes after the first play. The randomly fetched value 72 is used to index a historical play of the second play type by this player, in this example, a rush. The stats from that historical play of play type rush are retrieved from the historical database, published to the users and added to the fantasy points for teams that have that player in their starting lineup. For example, if the randomly indexed play of play type rush for this quarterback was a rush of 3 yards, then that would generate 0.3 points for the yards. That play, those stats and those points would be published to the users at the second time of play (in this case, 4 mins after the first play).

This is repeated for all of the forty plays for this player. In parallel, the flowchart of FIG. 2 is being performed for each of the other non-active players.

As another example, a running back may have play types: rush, reception, touchdown, and fumble. From the historical database 13 the play stats per game for this particular non-active running back in step 38 may be (for example):

| | rush | reception | touchdown | fumble |
|---|---|---|---|---|
| min | 14 | 0 | 0 | 0 |
| max | 33 | 4 | 3 | 1 |

In step 40 in this example, a random number of each play type is selected that is between each associated minimum and maximum. For example, step 40 may generate for this non-active running back 18 rushes, 2 receptions, 1 touchdown, and 1 fumble. These will be the play types for this player for this game.

The total play count for this non-active player for this contest would be calculated in step 42 as 22. In step 44, the list of play types generated in step 40 is shuffled for this player to create a randomly sequenced list of the play types, e.g. rush, rush, rush, rush, reception, touchdown, etc. (for all 22 plays).

In the play timeline 37, the same game duration that was used for the first player could be used again for every non-active player that day. Alternatively, a new game duration could be calculated independently for each non-active player. The times of play 52 would be calculated independently for each non-active player in either event.

At the first play time, in step 70 bar the example running back, a random integer is fetched (e.g. using one of the methods described herein). The value 72 is used to index a play of the first play type (in this example, a rush). Using the random integer, the play type played index 78 is indexed, and retrieves one of the historical plays by this player of the selected play type. One of this running, back's rushes is indexed by the random number. The values from that historical play are retrieved, the play is executed in step 80 and stored in the database 86. Those stats and those fantasy points for that play for that player are then published to the users and added to the fantasy points for teams that have that player in their starting lineup. For example, if the randomly indexed play of play type rush for this running back was a rush of 4 yards, then that would generate 0.4 points for the yards. That play, those stats and those points would be published to the users at the first time of play for this player.

Step 70 is repeated for each of the forty plays for this example running back. The second play is performed at the time of the second play. The randomly fetched value 72 is used to index a historical play of the second play type by this player, in this example, another rush. The stats from that historical play of play type rush are retrieved from the historical database, published to the users and added to the fantasy points for teams that have that player in their starting lineup. For example, if the randomly indexed play of play type rush for this running back was a rush of 18 yards, then that would generate 1.8 points for the yards. That play, those stats and those points would be published to the users at the second time of play (i.e. a certain time after the first play).

Note that when the play type “fumble” is retrieved from the historical database, the historical play that is retrieved may be “fumble lost” or “fumble recovered by own team.” “Fumble recovered by own team” would not result in a negative 2-point allocation.

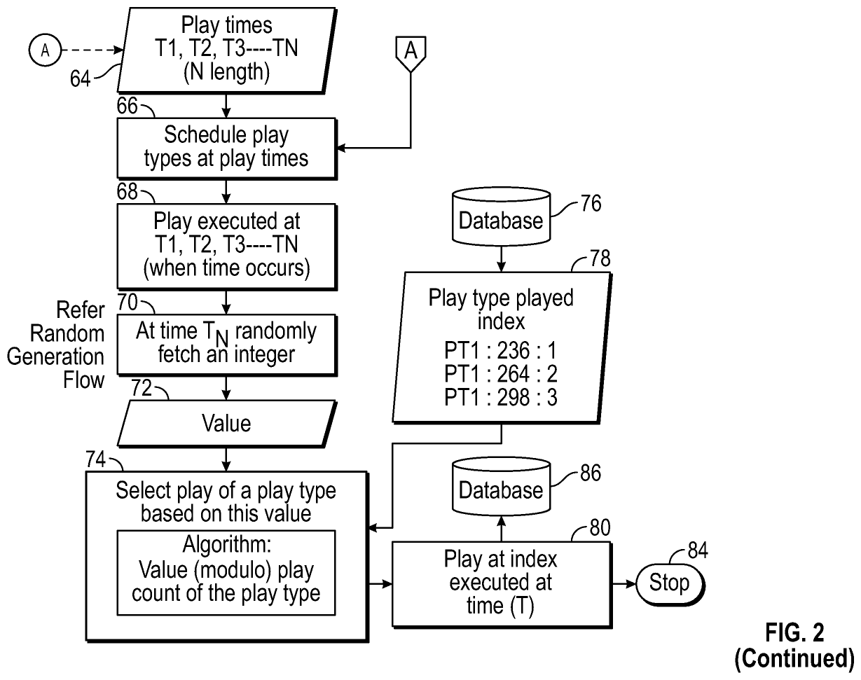

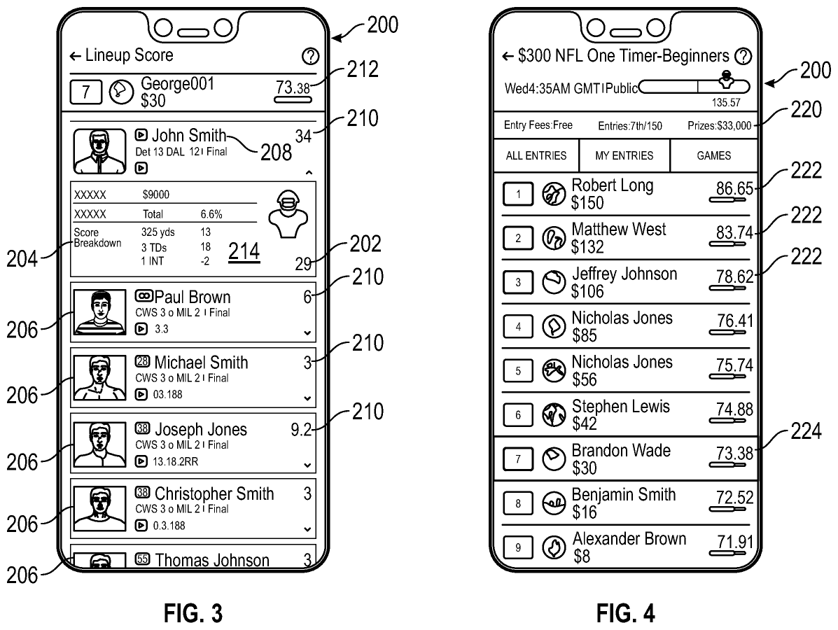

FIG. 3 shows a lineup screen 202 that is displayed in the app on a user's smartphone 200. A similar screen could be displayed in a web browser. The lineup screen 202 shows a list of the user's active players and non-active players with a short entry 206 for each player. Each short entry 206 may display the current running points total and picture of the player. if the player is active, the short entry 206 may also include a current status of the player's current game. If the player is historical (non-active), then the short entry 206 may include historical stats or current system-generated stats for this round. The total fantasy points 210 for each player (active or historical) are displayed. If the user selects one of the short entries 206, it is replaced with an expanded entry 204 which may display additional information 214 such as more detailed stats from this round. As is known in existing fantasy sports, the user's current total fantasy points 212 is the sum of the fantasy points 210 for each player in the user's lineup in this round.

FIG. 4 shows a standings screen 220. Each entry 222 represents a different user ranked based upon how many points they currently have. The smartphone's user has a highlighted entry 224 showing the user's place in the rankings.

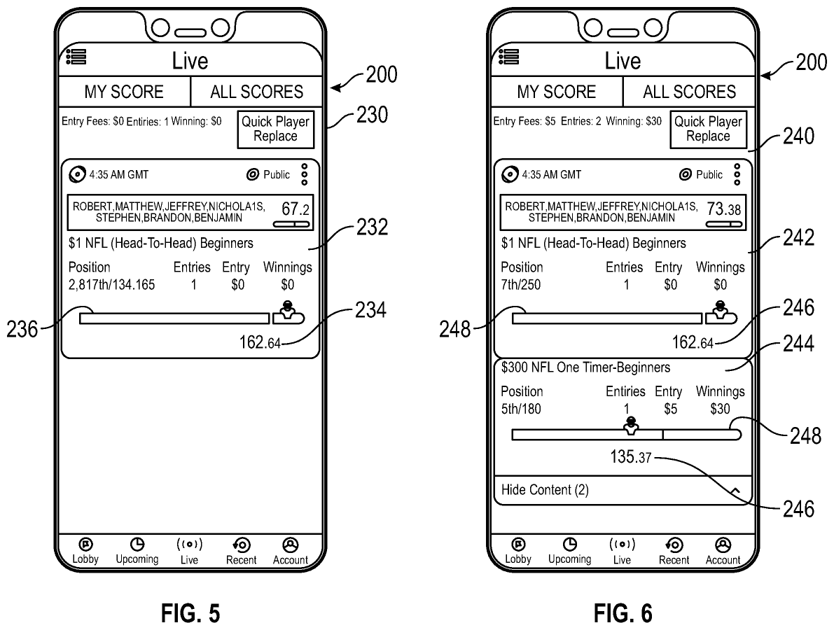

FIG. 5 shows a live contest screen 240 on the user's phone 200. The live contest screen 240 shows any currently-running contests in Which the user is participating, if any. In FIG. 6 example, the user has a first contest display 242 and a second contest display 244 for two different teams belonging to the user. Each contest display 242, 244 displays the current point total 246 and a graph 248 of the point total. As is known, users compete head-to-head each round (for football, each week) and the user with the higher number of fantasy points wins that head-to-head match.

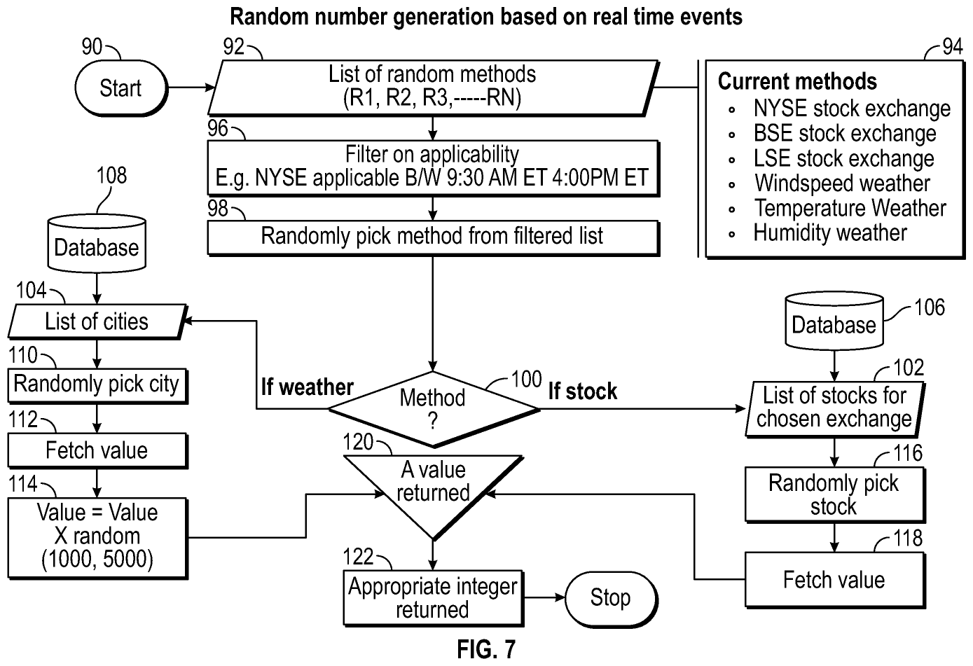

FIG. 7 shows a flow chart implementing one possible method for generating random numbers, which could be used in the method of FIG. 2. The random number generator begins in step 90 and accesses a list of available random method sources 94 in step 92. For example, the sources 94 could include the NYSE stock exchange, the BSE stock exchange, the LSE stock exchange, windspeed weather, temperature weather, humidity weather. In step 96, the available methods are filtered based upon applicability. For example, stock exchange information is only usable during business hours, etc. From the filtered list, one or more methods are randomly chosen in step 98.

In step 100, the selected methods are evaluated so that additional information can be retrieved. For example, if a weather-related method is chosen, a list of cities is accessed in step 104 from a database 108 of cities. In step 110 a city is randomly selected. In step 112, the relevant value is fetched. For example, if windspeed is the selected method, then the wind for the selected city is fetched. The value is then multiplied by a pseudorandom value to provide a number within a selected range (e.g. relevant to the number of plays being indexed). That adjusted value is returned in step 120.

If in step 100, it is determined that a stock exchange method is being used, then a. database list 106 of stock exchanges (and/or stocks) is accessed in step 102. In step 116, one or more of the stock exchanges (and/or stocks) is randomly selected. In step 118, the selected stock exchange (and/or stock) values are fetched. The values could be the exchange value, the stock value, exchange trade volume, stock trade volume or a truncated portion of those values. The relevant value is returned in step 120.

In step 122, the multiple values returned from the multiple methods are combined and/or used together to generate a random integer 122. The random integer is then handed to the appropriate algorithm (FIG. 2).

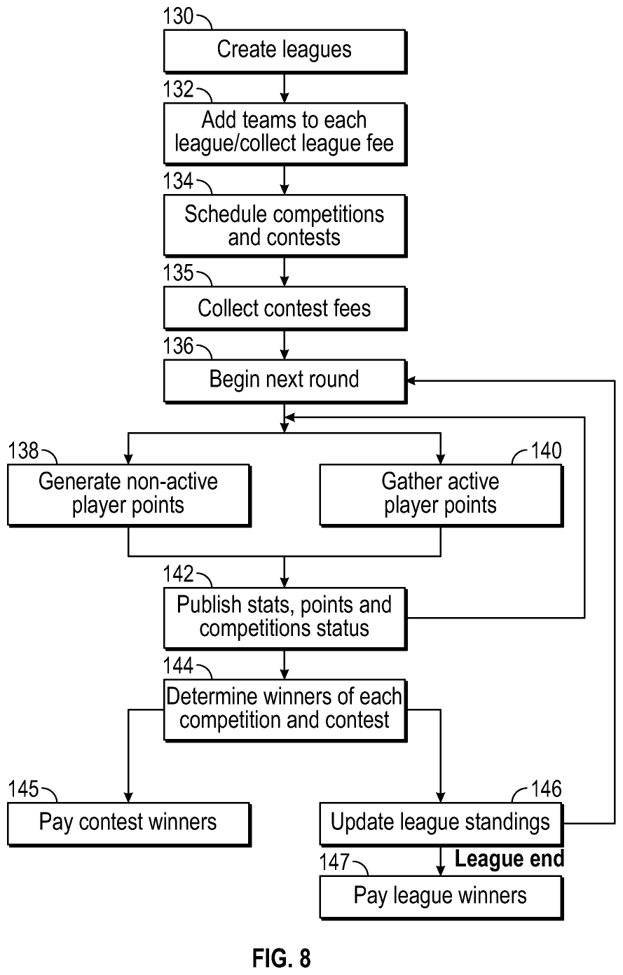

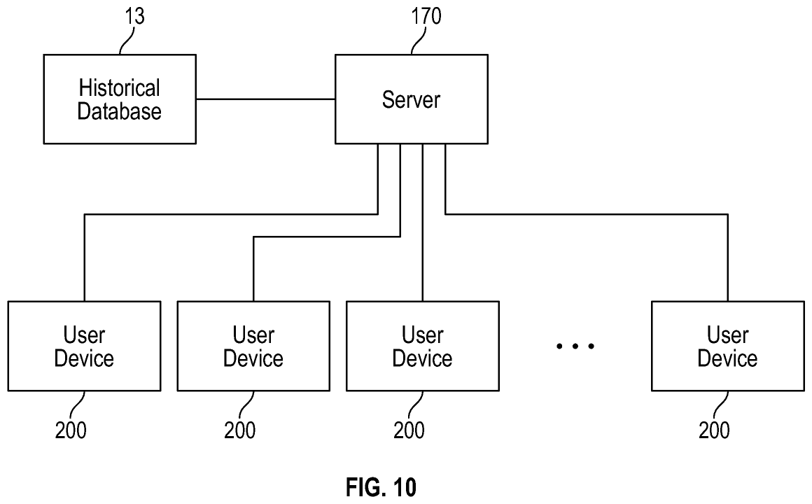

FIG. 8 shows one example possible flowchart that could be used to operate a platform that runs many (e.g. over one millions) leagues and millions of contests using the methods described above. The steps of FIG. 8 are performed on a server (e.g. server 170 of FIG. 10). The server has at least one processor with non-transitory computer-readable storage storing instructions which when performed by the at least one processor perform the steps of FIG. 8. As is known, the server would likely be a plurality of processors arranged as a cloud, cluster, and/or virtual server. The server would receive input selections from each of a plurality of players, such as via their smartphones and/or web browsers and/or apps.

In step 130, a plurality of leagues are created by the server based upon the input from the users in step 10 of FIG. 1. A plurality of teams are added to each league in step 132 (step 9 of FIG. 1) and a fee is collected from each user to enter one of the user's teams in each league. The fee is determined by the league. A user may have more than one team, and an individual team may be enrolled in more than one league. In step 134, the competitions are scheduled for all of the teams in all of the leagues.

The contests are also scheduled in step 134. Fees are collected in step 135 from a user for entering the user's team in a contest. The amount of the fee is determined by the contest. The single-round contest could be played by a user's team at the same time that the same user's team is participating in a league competition. The user's team could be entered in more than one contest at the same time. The contest could be limited to two users head-to-head, or the contest could be dozens or hundreds of users who are competing for the most points in a round, i.e. one performance of the FIG. 2 flowchart for each player in a starting lineup.

Each team has a roster, which can be altered during the season, as is known. Each team is controlled by a user who can designate a starting lineup before each round, as explained above. Again, in this system, the rosters and starting lineup can include non-active players alongside active players, or some leagues may be designated as being limited to non-active players.

In step 136, the next round is begun. For example, for football, each round is typically each week. Non-active player points are generated in step 138 according to the methods described above. Active player points are gathered in step 140 in a known manner. Periodically, e.g. every minute or every five minutes, the statistics, points and status of the competitions are published in step 142. Preferably, steps 138, 140 and 142 are performed at least once every five minutes and more preferably at least once every minute. Steps 138 and 140 are performed in parallel repeatedly throughout the duration of the round. As mentioned above, step 138 may be performed for thousands of non-active players, indexing hundreds of thousands of historical plays. For example, step 138 may be performed for more than 5,000, and preferably more than 10,000, and more preferably more than 15,000 non-active players. In this example, respectively, the system may be indexing over 280,000, preferably more than 560,000 and more preferably more than 840,000 historical plays, respectively, in step 138.

At the end of each round, the fantasy points accumulated for each team are compared to the opposing team in that round and the winners are determined in step 144. The winners of the contests are also determined in step 144. Again it is anticipated that there would be millions of competitions in each round for league play and millions of contests each round, all determined in step 144. The contest winners are paid their prize money in step 145 based upon the rules of the contest. The league standings are updated based upon the outcomes of each round in step 146. At the end of the league, the league winners are paid their prize money in step 147 based upon their league rules.

As explained above, whether in a league, season or a contest, each user may pay a fee (e.g. via credit card, cryptocurrency, etc) collected by the platform (e.g. server) to join a league, season or contest.

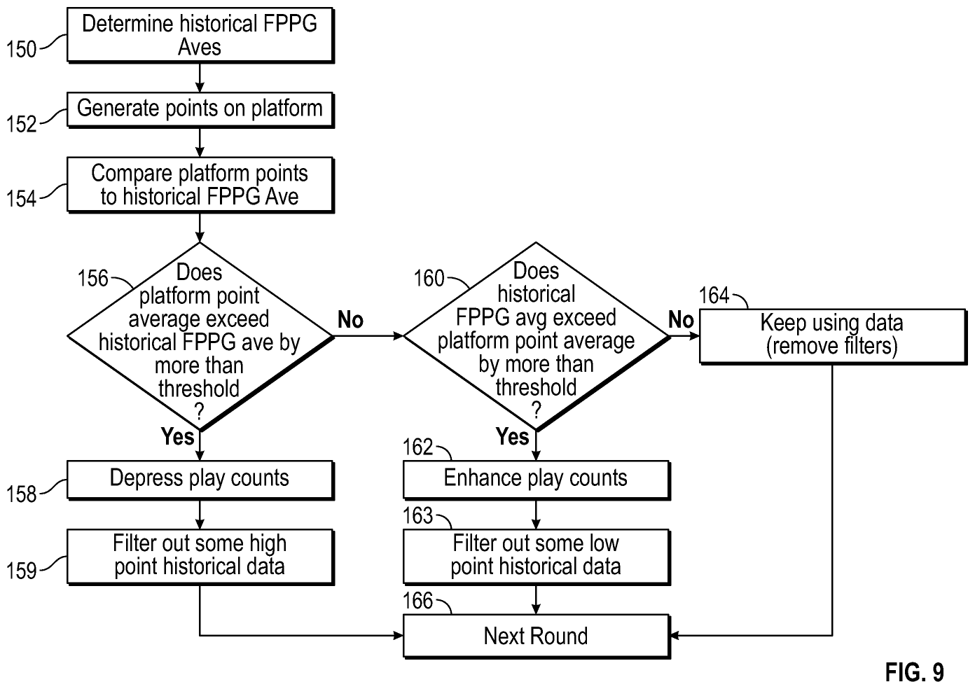

The flowchart in FIG. 9 shows an optional method that could be performed by the server. Generally, if on the platform, a non-active player's average fantasy points per game (FPPG) start to exceed (or lag) that player's actual historical average FPPG (from the historical data) by more than a certain threshold, then corrections may be made that will tend to move the player's platform FPPG toward that player's historical FPPG. Referring to FIG. 9, in step 150, the server determines the historical FPPG averages for the non-active player in terms of average fantasy points per game, average play counts per game for each play type and average yards per game. The steps of FIG. 9 are repeated for every non-active player on the platform, for example, after each round (or multiple rounds). In step 152, points are generated on the platform for the non-active player according to the methods described above. After a round (or multiple rounds), the player's platform FPPG are compared to that player's historical FPPG average in step 154. Optionally, the system may also randomly determine not to perform a correction for the next round.

In step 156, it is determined whether the player's platform FPPG exceeds the player's historical FPPG by more than a given threshold (e.g. by a certain percentage, alternatively a fix number of points per game, different for different positions could also be used as the threshold, a different percentage could be used for different positions). If so, then one or both of steps 158 and 159 can be used to converge the player's data before continuing to the next round in step 166.

In step 158, the player's play counts will be depressed. As a replacement for step 40 of FIG. 2, as one example method for depressing the player's play counts, the play count for each play type can be calculated as follows. A random (uniform) method is used to choose a play count between the player's minimum play count per game of the selected play type and the player's average play count per game of the selected play type. Additionally, the player's average play count per game of the selected play type may also be scaled to ensure that a randomly-generated play count will be less than the historical average. For example, it may be scaled by a constant less than one, e.g. 0.9 or 0.95. This may be repeated for every play type associated with this selected player (or at least, for the positive-point plays). These depressed play counts of each play type would then be used in steps 42 and 44 of FIG. 2.

In step 159, some high point historical plays may also be filtered out or blocked. For example, when play continues in the next round 166, the random selection of a historical play in step 74 of FIG. 2 may be limited to those plays that yield points (e.g. yards) between the minimum and the player's average points (yards) per play. Additionally, the player's average points/yards per play may be scaled by a constant less than one (e.g. 0.9 or 0.95). This filtered data may be used for every play by the player in this round.

If the player's platform FPPG do not exceed the player's historical FPPG by more than a given threshold in step 156, then it is determined whether the player's historical FPPG exceeds the player's platform FPPG by more than a given threshold (again it may be a percentage and it may be the same percentage used in step 156). If so, then one or both of steps 162 and 163 can be used to converge the player's converge the player's data before continuing to the next round in step 166.

In step 162, the player's play counts will be enhanced. As a replacement for step 40 of FIG. 2, as one example method for enhancing the player's play counts, the play count for each play type can be calculated as follows. A random (uniform) method is used to choose a play count between the player's average play count per game of the selected play type and the player's maximum play count per game of the selected play type. Additionally, the player's average play count per game of the selected play type may also be scaled to ensure that a randomly-generated play count will be greater than the historical average. For example, it may be scaled by a constant greater than one, e.g. 1.1 or 1.05. This may be repeated for every play type associated with this selected player (or at least, for the positive-point plays, e.g. not interceptions or fumbles). These enhanced play counts of each play type would then be used in steps 42 and 44 of FIG. 2.

In step 163, some low point historical plays may also be filtered out or blocked. For example, when play continues in the next round 166. the random selection of a historical play in step 74 of FIG. 2 may be limited to those plays that yield points (e.g. yards) between the player's average points (yards) per play and the maximum. Additionally, the player's average points/yards per play may be scaled by a constant greater than one (e.g. 1.1 or 1.05). This filtered data may be used for every play by the player in this round.

If the platform point average neither exceeds (step 156) not is exceeded by (step 160) the historical FPPG average by more than the threshold, then it is determined to use the unfiltered/unblocked historical data in step 164. Play continues in the next round with the unfiltered/unblocked historical data in step 166, without any depressed or enhanced play counts or any filtering of high or low point plays. Over time, the flowchart of FIG. 9 will converge the player's platform FPPG toward the player's historical FPPG.

Although the inventive system and method have been described with respect to football, they can be used with any sport that has an associated fantasy sport to introduce the ability to use non-active players. Such sports include, but are not limited to baseball, hockey, basketball, soccer, cricket, etc).

Although “non-active” has been described in the examples above to mean retired or permanently non-active, “non-active” in this application could also mean that the player (and sport) is in the off-season, is injured (and temporarily inactive), or that the player is active in their real-life sport, but that the platform or league or contest has selected not to use any live, future data, but to be based solely on that player's historical data (i.e. all data stored prior to the date of the contest).

Referring to FIG. 10, except as otherwise specified, all of the steps in the foregoing description are performed on a server 170 (which can be a virtual server, cloud server, server cluster, or any other hardware or software arrangement—having at least one processor and storage storing instructions for performing these steps) which receives input and selections from users via the user devices 200, which can be smart phones, tablets, or computers either through a dedicated application (preferably) or through a web browser. As noted above, the server 170 accesses historical play information on the historical database 13.

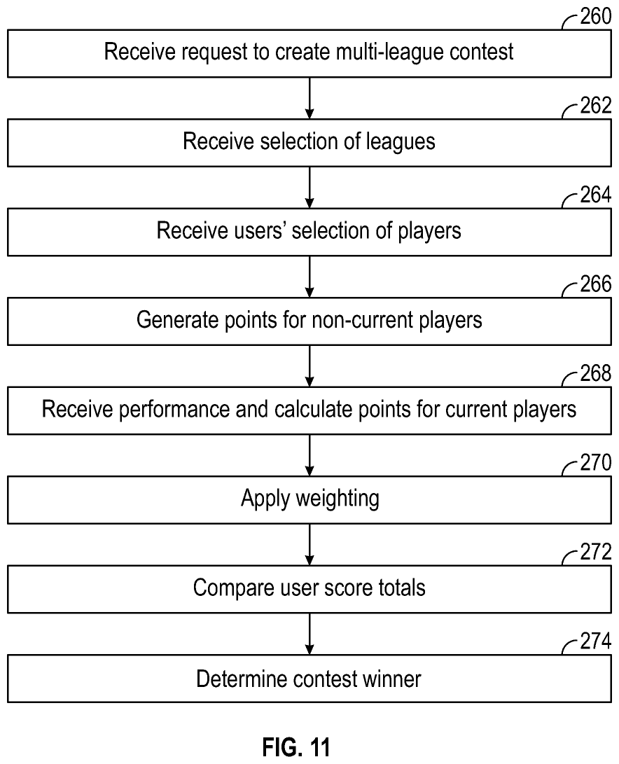

Referring once again to FIG. 1, in step 8, a user may also be able to create (or join) a multi-league contest. Turning to FIG. 11, the user chooses to create a multi-league contest in step 260. The user then selects two or more leagues to be in the contest in step 262. More preferably, the user selects three or more leagues. As used herein, “league” refers to different, mutually exclusive, associations of sports teams. The leagues may he different sports, pro/semi-pro/collegiate, with different seasons, on different continents, and in different times (e.g. past vs. present). For example, the user can select from: a current or defunct professional baseball league (e.g. MLB), a current or defunct professional football league (e.g. NFL, CFL), a current or defunct professional hockey league (e.g. NHL, AHL, CHL), a current or defunct professional basketball league (e.g. NBA), college sports leagues (e.g. NCAA, NAIA) of any sport, a current or defunct professional soccer league (e.g. MLS), current or defunct non-North American leagues (e.g. English Premier League, EuroLeague, Nippon Professional Baseball, China Basketball Association, Kontinental Hockey League).

The creator and other users then create their teams by selecting one player from each of the selected leagues in step 264. Alternatively, the creator can specify that each user chooses more than one player from each of the selected leagues. Alternatively, the creator can specify that each user must select players from a minimum number of distinct leagues. As before, the players selected by the users may be current players in a current season, current players in an off-season, or retired/inactive players, or more preferably, a combination of these types of players.

The system then generates points for any inactive or retired or off-season players in step 266 based upon their historical career statistics (or alternatively, the most recent season's statistics using the system and methods described above. In alternative examples, any alternative suitable method can be used to similar effect.

In step 268, the system receives the performance statistics from current players from their most recent game (after the contest has begun). The system also calculates the fantasy points for each current player based upon these performance statistics. Steps 266 and 268 are performed in according with the methods described above.

In step 270, one or more optional weightings may be applied to each score. First, it may be desirable to normalize the fantasy points across the different leagues, particularly different sports. For example, basketball players often score forty or more fantasy points in a game while baseball players typically score less than five. A baseball player's fantasy points could be weighted, for example, multiplied by ten, so that each sport/league contributes meaningfully to the user's score. Precise weighting between sports is not required because each user has the opportunity to have same number of players from each of the same leagues; however, in order to make player selection from each league potentially outcome-determinative, some weighting should be applied.

Additionally, it may also be desirable to apply some weighting based upon position within a given sport or league. For example, in a contest in which each user can select an NFL player at any position, there may be a weighting applied based upon position. For example, a multiplier may be applied to a tight end to bring his score in line with a typical quarterback. Alternatively, the creator can designate that each user chooses one or more players from one or more designated positions (e.g. 1 QB and 1 WR). Again, if it is chosen to use weighting, the weighting should be applied so that any player selected will have the potential to contribute meaningfully to the outcome of the contest, between users.

As another alternative, instead of or in combination with weighting, a contest may total several games from some of the players depending upon their sport and/or league (and the typical level of fantasy sport scoring in that sport/league). For example, a contest may include total fantasy points from three games (live and/or simulated, as above) from a baseball player, optionally multiplied by a weighting factor (e.g. three), plus an NFL quarterback's fantasy points (again live or simulated as above), plus an NBA player's fantasy points (again, live or simulated as above). These leagues have periods of overlap, so whether live data can be used depends on what time of year the contest is run, and the above-described simulation can be used for whichever league(s) is not currently playing.

The fantasy points and contest standings are rolled out over time as previously described with respect to FIG. 2. When the live games are completed and the simulated games have been completed, the user scores compared in step 272 and a winner is declared in step 274.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A computer-implemented method for operating a fantasy sports system including:
a) receiving at a server a plurality of player selections from a plurality of users, the plurality of selections including a set of players from a first league and a set of players from a second league, each of the users having selected a player from each of the first and second league;
b) creating a fantasy team on the server for each of the plurality of users based upon said step a):
c) the server generating a first set of fantasy points for players from the first league and a second set of fantasy points for players from the second league;
(d) the server generating a total fantasy score for each fantasy team based upon the fantasy points generated in step c) for each of the players from each of the first league and the second league associated with said each fantasy team.

2. The method of claim 1, wherein the plurality of selections includes at least one additional set of players from a third league.

3. The method of claim 1, wherein the first league and the second league are distinct sports.

4. The method of claim 3, wherein each player in the first league and each player in the second league is classified by a position, and wherein all users select players having the same position from the same league.

5. The method of claim 3, wherein each user selects the same number of players from each league as each other user.

6. The method of claim 1, further comprising applying a weighting multiplier to at east one of the first set of fantasy points and the second set of fantasy points.

7. The method of claim 6, wherein the weighting multiplier is a single multiplier and is dependent on the sport corresponding to the at least one of the first league and the second league.

8. The method of claim 6, wherein the weighting multiplier is a combination of a multiplier dependent on the sport corresponding to the at least one of the first league and the second league and a multiplier dependent on a position of the player.

9. The method of claim 1 wherein generating the first set of fantasy points for players from the first league comprises generating fantasy points from a plurality of games for each player in the first league and wherein generating the second set of fantasy points for players from the second league comprises generating fantasy points from a single game for each player in the second league.

10. The method of claim 9, wherein the first set of fantasy points is normalized with the second set of fantasy points by further applying a weighting multiplier to the first set of fantasy points.

11. The method of claim 1, wherein the first league and the second league include overlapping game schedules.

12. The method of claim 1 wherein at least some of the plurality of player selections in at least one of the first league and the second league are for non-active players, and wherein step C generates fantasy points for each of the non-active players by randomly selecting a plurality of historical plays by the non-active player from a database of historical plays.

13. The method of claim 12 wherein said step c) further includes, for each non-active player, determining a game duration and a number of plays.

14. The method of claim 13 wherein said step c) generates fantasy points for each of the non-active players at randomly-determined time intervals based upon the determined game duration and number of plays.

15. The method of claim 12 wherein the non-active players are non-active football players.

16. The method of claim 12 wherein said step c) further includes the step of generating a random value based upon an exterior index.

17. The method of claim 16, wherein the exterior index is selected from a list of indexes including a weather condition index and a stock exchange value index.

18. The method of claim 17, wherein the exterior index is randomly selected from the list of indexes.

19. The method of claim 17, further comprising applying a modulo to the random value from the from the selected exterior index.

20. The method of claim 12 further including the step of comparing a historic fantasy points average based upon the database of historical. pays to an accumulated average fantasy points per game generated in step c), and altering future performances of step c) in a way that would tend to converge the accumulated average fantasy points per game generated in step c) toward the history fantasy points average.

21. A fantasy sports gaming system comprising:
at least one processor;
at least one non transitory computer-readable media storing a database of historical plays by non-active players, the media further storing instructions which when executed by the at least one processor cause the at least one processor to perform operations, the operations comprising:
a) receiving at a server a plurality of player selections from a plurality of users, the plurality of selections including a set of players from a first league and a set of players from a second league, each of the users having, selected a player from each of the first and second league;
b) creating a fantasy team on the server for each of the plurality of users based upon said step a);
c) the server generating, a first set of fantasy points for players from the first league and a second set of fantasy points for players from the second league;
d) the server generating a total fantasy score for each fantasy team based upon the fantasy points generated in step c) for each of the players from each of the first league and the second league associated with said each fantasy team.

22. The fantasy sports gaming system of claim 21, wherein the plurality of selections includes at least one additional set of players from a third league.

23. The fantasy sports gaming system of claim 21, wherein the first league and the second league are distinct sports.

24. The fantasy sports gaming system of claim 23, wherein each player in the first league and each player in the second league is classified by a position, and wherein all users select players having the same position from the same league.

25. The fantasy sports gaming system of claim 23, wherein each user selects the same number of players from each league as each other user.

26. The fantasy sports gaining system of claim 21, further comprising applying a weighting multiplier to at east one of the first set of fantasy points and the second set of fantasy points.

27. The fantasy sports gaming system of claim 26, wherein the weighting multiplier is one of a single multiplier dependent on the sport corresponding to the at least one of the first league and the second league and a combination of a multiplier dependent on the sport corresponding to the at least one of the first league and the second league and a multiplier dependent on a position of the player.

28. The fantasy sports gaming system of claim 21, wherein generating the first set of fantasy points for players from the first league comprises generating fantasy points from a plurality of games for each player in the first league and wherein generating the second set of fantasy points for players from the second league comprises generating fantasy points from a single game for each player in the second league.

29. The fantasy sports gaming system of claim 21, wherein at least some of the plurality of player selections in at least one of the first league and the second league are for non-active players, and wherein step C generates fantasy points for each of the non-active players by randomly selecting a plurality of historical plays by the non-active player from a database of historical plays.

30. The fantasy sports gaming system of claim 22 wherein said step c) further includes, for each non-active player, determining a game duration and a number of plays.

31. The fantasy sports gaming system of claim 30 wherein said step c) generates fantasy points for each of the non-active players at randomly-determined time intervals based upon the determined game duration and number of plays.

32. The fantasy sports gaming system of claim 22 Wherein the non-active players are non-active football players.

33. The fantasy sports gaming system of claim 22 wherein said step c further includes the step of generating a random value based upon an exterior index.

34. The fantasy sports gaming system of claim 33, wherein the exterior index is selected from a list of indexes including a weather condition index and a stock exchange value index.

35. The fantasy sports gaming system of claim 34, wherein the exterior index is randomly selected from the list of indexes.

36. The fantasy sports gaming system of claim 34, further comprising applying a modulo to the random value from the from the selected exterior index.
